(19) United States
(12) Patent Application Publication
(10) Pub. No.: US 2023/0168659 A1
(43) Pub. Date: Jun. 1, 2023

(54) ELECTRONIC PRODUCTION CONTROL

(71) Applicant: Bionic Production GmbH, Lüneburg (DE)

(72) Inventors: Daniel BECK, Hamburg (DE); Léon KLICK, Krummesse (DE)

(73) Assignee: Bionic Production GmbH, Lüneburg (DE)

(21) Appl. No.: 17/718,023

(22) Filed: Apr. 11, 2022

(30) Foreign Application Priority Data
Nov. 26, 2021 (DE) 102021131085.7

(51) Int. Cl. G05B 19/4097; G05B 19/408; G05B 19/4155; H04L 9/00

(52) U.S. Cl. CPC G05B 19/4097; G05B 19/4083; G05B 19/4155; H04L 9/50

(57) ABSTRACT

The invention relates to a method for electronically monitoring production by means of at least one production device, at least one enabling data set being provided for the production device and the production device being able to be operated depending on the enabling data set in order to manufacture a product on the basis of a production data set.

### CROSS-REFERENCE TO RELATED APPLICATIONS

This application claims foreign priority to German Patent Application No. DE 102021131085.7, entitled “ELECTRONIC PRODUCTION MONITORING,” naming as inventors Daniel Beck and Léon Klick, and filed Nov. 26, 2021, the subject matter of which is hereby incorporated herein by reference.

### TECHNICAL FIELD

The present invention relates to a method and a device for electronically monitoring production.

Advancing digitalization in nearly all areas of industrial production provides various opportunities for manufacturing products in a flexible and low-cost manner. Production orders can thus now be fulfilled completely digitally, wherein a production specification of the product to be manufactured is present in electronic file formats, such as an NC file, in addition to the order data. The electronic specification or production data can be processed directly by modern production devices, such as 3D printers, thus reducing the configuration effort for the machines.

Due to the now standardized file formats for electronic production data, and the increasing availability of universally usable production devices such as 3D printers, it is further possible to flexibly network various authorities to a suitable production device in order to manufacture an arbitrary product, such as a spare part needed in the short term. For example, a provider of spare parts can provide the same to a customer in the form of electronic production files, so that said customer can have the spare parts manufactured by a selected operator of a production device.

The increasing opportunities for networking in the production field, however, are associated with risks. One risk aspect is that a plurality of authorities or institutions are involved in a production process or at least influence said process. For example, a provider of production files, unlike a conventional provider of finished manufactured products, cannot itself guarantee the quality of the products produced. The quality of a product does also depend on the specification thereof. The actual quality of the product produced, however, also depends on the production, that is, on the manner in which the relevant product is manufactured. Any quality defects of the product can therefore revert to the provider of the production file, in the worst case, even though said provider is not responsible for the quality defect. The authorities involved in the production process thus have only limited control of the quality themselves.

A further problem is that production files can spread unchecked and particularly can be confused or counterfeited. For example, a production file can represent a complex, valuable component easily manufactured by an unauthorized third party by means of a suitable production device and able to be marketed without the necessary quality checks. Fraudulent use of production files, however, is not always easily detected. For safety-related components, such as spare parts for vehicles, however, sufficient quality should always be ensured.

There is a further risk that a product will be produced by means of an unsuitable production device. The production file used, however, can be perfect. Quality deficiencies can also occur in this manner and are difficult to detect afterward.

Networked production architectures are therefore susceptible, in principle, to all kinds of errors and manipulation. In other words, the requirements for networked production are greater than for classical production processes provided by a “single source.” A high and reliable level of production quality, however, can be ensured only if all of the means and authorities involved in production are free of errors and correctly mutually coordinated.

The object of the invention is to disclose a method for electronically monitoring production, particularly in order to ensure reliable production quality in networked production architectures.

The object is achieved according to a first consideration by a method having the features of claim 1, and particularly in that at least one enabling data set is provided for a production device and the production device can be operated depending on the enabling data set in order to manufacture a product on the basis of a production data set.

The solution is based on providing enabling data sets usable in conjunction with at least one production device. One such enabling data set is particularly provided for a production device, so that the production device can be operated depending on the enabling data set in order to produce a product on the basis of a production data set.

One enabling data set represents one data-based means for controlling a production device. For example, operating the production data set can be selectively enabled depending on an enabling data set in order to be able to manufacture a related product on the basis of a production data set by means of the production device. Without the enabling data set, in contrast, the production device cannot be operated for manufacturing the product on the basis of the production data set.

The enabling data set can thus be adapted for enabling or blocking a production data set depending on the enabling data set, particularly with respect to a production data set to be used as the basis for operating the production device. In this manner, electronic production monitoring is implemented, by means of which both the use of production devices and the use of production data sets can be controlled and monitored. A desired production quality can therefore also be reliably ensured for networked and particularly decentralized production architectures.

The production device is generally a device for manufacturing products. Said device can comprise devices for producing new products from raw materials, such as additive production devices, particularly 3D printers or the like. Manufacturing processes also comprise machining procedures, such as milling or forming products. The production device can thus also be adapted for manufacturing a product by machining.

A product, in general, is the product of a manufacturing procedure. Particularly included are components of all kinds, such as spare parts. Other types of products, however, are also conceivable. Spare parts are often required in the short term at a wide variety of locations around the world, and can therefore be manufactured advantageously by means of a decentralized production architecture. The production quality can, however, be reliably ensured by means of the method according to the invention.

Electronic production monitoring according to the invention has the advantage that individual manufacturing procedures can be specifically enabled, for example, by providing the enabling data sets with precisely specified validity data. The use of enabling data sets thus allows a high level of monitoring depth. Customized production solutions can also be offered for minimizing the control and administration effort for the user.

The enabling and production data sets are preferably each implemented by electronic data sets able to be flexibly saved and transferred between various network authorities. Separating enabling and production data sets allows improved reliability of production monitoring, particularly when the data sets are provided by different authorities and predetermined authentication criteria must be met for this purpose.

Each enabling data set is preferably provided in an electronic manner, for example, in that the enabling data set is transferred via the Internet or another communications network to a predetermined production device, for example, from a central server or an authority of a decentralized data structure. It is also conceivable that one enabling data set is provided in that said data set is read from a memory and made usable in this manner. Providing the enabling data set can also comprise generating the same.

Embodiments of the invention are disclosed in the description, the figures, and the claims.

According to one embodiment, the enabling data set is provided depending on an authorizing data set. For example, the enabling data set can be transmitted to the production device depending on the authorizing data set, that is, the enabling data set cannot be received by the production device until an associated authorization has been previously demonstrated in the form of an authorizing data set. In this manner, the use of the enabling data set for operating a production device can be monitored more reliably in order to prevent any misuse or erroneous use.

Each authorizing data set can, in general, be generated by one authorizing authority, so that one order authority can prove authorization thereof for using the enabling data set and/or the production data set. For example, the order authority (e.g., the customer) can prove authorization with respect to one providing authority providing the enabling data set. The authorizing data set can particularly represent proof that the customer or the order authority has paid compensation for using the production data set and/or the production device.

For further improving production monitoring, it is possible that the authorizing data set and/or the enabling data set are authenticated in order to enable the production device for producing the product on the basis of the production data set. For example, the authenticity of the enabling data set can be verified by querying a decentralized data structure. Only then can the production device be enabled. A plurality of enabling data sets or other data can be saved in the decentralized data structure and serve as a reference for authenticating provided enabling data sets. The decentralized data structure can particularly be implemented by a blockchain.

At least one predetermined production data set is preferably associated with the enabling data set, so that the enabling relates to the use of the predetermined production data set. To this end, the enabling data set can comprise a first identifier for identifying one or more production data sets. The link between the enabling data set and the production data set implemented in this manner can be utilized for production monitoring in many ways. For example, the production data set can be provided to the production device depending on the first identifier. This can be done in that a relevant production data set, for example, is called up from a central server depending on the identifier and transmitted to the production device. The production data set can accordingly not be provided for using with the production device until the identifier of the production data set has been successfully read from the enabling data set. Production monitoring is thereby further increased.

The production data set can be saved remotely with respect to the production device, so that, for example, a pool of production data sets can be managed and monitored independently of the production device. However, this is not necessary. Alternatively, the required production data set can be saved in a local memory of the production device and read out therefrom depending on the identifier.

According to a further embodiment, the enabling data set forms a part of an element of a decentralized data structure. This enables advantageous utilizing of existing networks in order to efficiently and reliably implement the production monitoring. Security is also increased in comparison with a centralized data structure, as said structure is more vulnerable in principle. The decentralized data structure is preferably implemented by means of distributed ledger technology, particularly by a blockchain, that is, by a flexibly expandable list of data sets. The individual data sets are permanently stored in blocks of the blockchain, respectively, wherein the blocks can be connected to each other by means of cryptographic hash functions. Each enabling data set is saved in one block of the blockchain. A plurality of enabling data sets can also be saved per block.

The data sets described here, particularly the enabling data set and the authorizing data set, are preferably provided in the form of what are known as tokens, particularly in the form of non-fungible tokens (NFT). The tokens can be implemented as software tokens on the basis of a blockchain comprising identification and/or authentication data for the purpose of electronic production monitoring.

The data sets described are preferably separate from each other. This enables efficient utilization of the available bandwidth for data transfer, for example, because an extensive production data set need not be transferred together with a compact enabling data set. It is, however, conceivable that the production data set is part of the enabling data set.

The enabling data set can in general be implemented for controlling the utilization of production devices and production data sets. For example, the enabling data set can be implemented such that said data set can be used exclusively for operating a predetermined production device, for example, in that the enabling data set has an identifier for an associated production device and the providing of the enabling data set is made dependent on the identifier. The enabling data set is preferably provided to the production device in this case only when the production device has previously been authenticated by means of the identifier.

The enabling data set is preferably further designed so that said enabling data set authorizes producing a predetermined quantity of copies of the product, particularly exactly one copy, on the basis of the production data set. The utilization of the production data set and/or of the production device can thus be controlled precisely depending on the requirements of the ordering authority. Preferably, the enabling data set is unique and authorizes producing exactly one copy or exemplar of the product.

According to an embodiment, the enabling data set is not modified, duplicated or subject to generation of a further enabling data set. In this way, an enabling data set is unique and protected against fraud. It is preferred that only a single enabling data set is required to operate the device in order to manufacture a product. The amount of data processing required for electronic production monitoring can be reduced in a comparison to cases in which a plurality of enabling data sets must be processed. In this context, it can further be ensured that the generation or use of the enabling data set does not depend from another enabling data set, particularly from the content of another enabling data set. Except for the production data set the enabling data set may represent the only data set required for enabling the production device to manufacture a copy of the product on the basis of the production data set.

In another embodiment, the enabling data set is provided depending on an authorizing data set, wherein the enabling dataset is associated with the production device and the production data set, and the authorizing data set is associated with the enabling data set. In this way, the specific data required for the manufacturing may be exclusively assigned to the enabling data set, wherein the authorizing data set can be limited to authorizing use of the enabling data set without any specific manufacture information (e.g. production device, production data set).

In one embodiment, the enabling data set is implemented as a non-fungible token of a blockchain.

As an optional feature, the enabling data set can comprise status data. A current use of the enabling data set can thus be made transparent, particularly with respect to one or more monitoring authorities implementing the production monitoring. For example, the status data can represent a memory location of the enabling data set, an accessing authority, and/or an activation for intended use of the enabling data set. However, in a preferred embodiment, an enabling data set does not comprise status data.

As a further optional feature, the status data can be modified before and/or after operating the production device, particularly before and/or after producing the product. In this manner, the use of the data set can be made transparent to other authorities, for example by an operating authority, so that production monitoring is further improved. The status data can also indicate the authority having current access to the enabling data set. This also enables better monitoring of the use of the enabling data set. However, it is preferred that the status data cannot be modified, thus enhancing the security and integrity of the data.

According to a further embodiment, the enabling data set is invalidated depending on a first confirmation of successful manufacture. It is thus ensured that the enabling data set cannot be reused after successful manufacture. This may be independent from a number of attempts to manufacture the product, i.e. the enabling data set may authorize for an unlimited number of production attempts but is invalidated immediately in response to a successful production attempt. The inspecting authority can monitor the attempts and detect a successful attempt, wherein this data may be logged on a blockchain independent from the enabling dataset. Preferably, an enabling data set authorizes manufacture of exactly one copy of the product.

The confirmation required for invalidating can be produced automatically or manually, as explained below in greater detail. Time-based cancellation of the enabling data set is also conceivable, for example, after a predetermined span of time has passed after activating use of the enabling data set. After cancellation, the enabling data set is no longer usable for manufacturing the desired product on the basis of the production device, that is, the production device is blocked for this purpose depending on the (invalidated) enabling data set. The production device can, however, be operated for other purposes, for example, for enabled production data sets.

Invalidating the enabling data set can be done, for example, by modifying or deleting validity data (if present), potentially as part of the enabling data set. Alternatively, the enabling data set can be deleted or transmitted back to a providing authority.

Due to the electronic production monitoring, the success of manufacturing can indeed be securely ensured to a high degree. Any production problems during manufacturing of the product cannot, however, be completely prevented. Such problems can be handled by generating and providing a new enabling data set if manufacturing was not successful. Alternatively, an existing enabling data set can be provided with validity data for another manufacturing attempt depending on a second confirmation of unsuccessful manufacturing. It can thereby be avoided that an enabling data set is cancelled even though manufacturing was not successful. Sufficient production quality cannot always be guaranteed on the first attempt for 3D printers, for example, for various reasons. The configuration parameters, however, can often be adapted so that a subsequent manufacturing attempt leads to a satisfactory result. In order to avoid having to provide a new enabling data set for such manufacturing attempts, the validity data can be updated as needed. The effort for management and data transfer for production monitoring is thus reduced. At the same time, trouble-free manufacturing can be achieved with a high level of user satisfaction. Extending validity can be made dependent on a separate confirmation from a trustworthy authority in order to avoid misuse. However, for reasons of increased security and data integrity, it is preferred that the enabling data set is not modified by adding or modifying validity data. In one embodiment an enablement data set authorizes for one manufacturing attempt only.

The first confirmation, that is, the confirmation able to be submitted for determining a successfully produced product, is preferably generated depending on first automatically generated operating data of the production device and/or first input data of an expert authority for assessing the manufactured product. For example, the production device can determine the completion of a manufacturing process using internal operating data.

In addition, an inspecting authority or institution can be entrusted with the task of checking the quality of the product produced. If the quality is sufficient, said determination is transmitted in the form of input data, so that the enabling data set can be properly invalidated. The input data can be captured in the form of a signature on a graphic user interface of the production device, for example. The inspecting authority can accordingly be implemented by a trained person, that is, an expert assessor, or by an inspecting device, for example.

The second confirmation of unsuccessful manufacturing can generally be generated depending on second automatically generated operating data of the production device and/or second input data of the inspecting authority or institution and/or third input data of a monitoring authority. Additional inputting by a monitoring authority is particularly advantageous in order to prevent improper extension of validity of the enabling data set or generation of a new enablement data set. For example, the monitoring authority can verify the second input data or at least check for plausibility using the second operating data.

The monitoring authority can be a trustworthy person tasked with monitoring. Alternatively or in addition, the manufacturing failure can also be determined or verified using computer support. The available data can be evaluated by means of an AI model, for example, for this purpose.

In the event of an unsuccessful manufacture, the monitoring and/or inspecting authorities can provide diagnostic data indicating reasons for the failure. For example, the diagnostic data can indicate that the reasons for the failure may rely in the production data set and/or the production device.

According to a further embodiment, an authorizing data set can be generated depending on invalidating the enabling data set. For example, an authorizing data set can be generated in order to subsequently consolidate or document the authorization for using the production data set. Said step can be optionally dispensed with if the enabling data set has already been provided depending on a previously generated authorizing data set, as described above.

The authorizing data set can particularly represent information that an electronic credit is being or has already been issued for the benefit of a provider of the enabling data set and/or of the production data set, particularly by automatically initiating an electronic transaction according to a predefined, computer-implemented program sequence. The credit can be issued partially for the benefit of other authorities as well, such as an operator or provider of the production device.

The dependency on the authorizing data set can be advantageously used such that such authorities having contributed to producing the product receive compensation for the same. If the authorizing data set is generated only after manufacturing, then this is preferably done automatically, that is, without manual input, so that the authorization is reliably ensured.

It must be understood that the method for electronically monitoring production can be implemented by various persons or general authorities. The function of the authorities can be implemented at least partially by electronic devices, such as a computer or a server. Accordingly, the method for electronically monitoring production can be partially or fully computer-implemented.

Within the disclosure, authorities having different functions are described separately for clarity. The functions performed by individual authorities can, however, be implemented partially by one common authority, so that the quantity of authorities involved can be reduced.

In general, the method can be initiated by an ordering authority wishing to manufacture a particular product for itself or for a third party. The method for electronically monitoring production can comprise the additional step, for this purpose, that an order data set is received by an ordering authority.

The order data set comprises at least one piece of information about a predetermined product to be manufactured depending on the enabling data set. In addition, further information, such as about desired production parameters (e.g., materials to be used) can also be present in the order data set. A providing authority can then generate an enabling data set on the basis of the order data set.

The enabling data set preferably comprises an identifier for identifying the production data set required for manufacturing the predetermined product. The enabling data set can then be provided for an operating authority of the production device in order to produce the predetermined product.

In order to further increase the reliability of monitoring production, according to a further embodiment, the production data set is encrypted, or at least is provided in encrypted form. The encrypted production data set can thus be used effectively only by those authorities having the suitable key for decrypting. From the point of view of the production device, however, the enabling data set is preferably also required in order to provide and to read the production data set, wherein the enabling data set can comprise access data for reading the production data set for this purpose. The enabling data set can also be at least partially encrypted.

The access data can comprise a first key for decrypting the production data set, according to one embodiment. The first key can particularly be a symmetric key also used for encrypting the production data set.

The first key is preferably generated by means of a second key. The second key can be a private key associated with one providing authority generating and/or providing the production data set.

To further increase security, the first key can be encrypted by means of a third key. The third key can be a public key, for example, associated with a predetermined production device. The first key and the production data set can thus be decrypted only by the predetermined production device having the associated private key. Accordingly, only the predetermined production device can access the production data set.

With respect to the potential for encrypting as described, it is preferable that the access data comprises at least one hash value for the production data set.

According to a further embodiment, the enabling data set comprises a second identifier for uniquely identifying the production device. Alternatively or in addition, a third identifier for uniquely identifying the enabling data set can be provided, so that each enabling data set can be provided with a unique signature. The enabling data set can further comprise a fourth identifier for uniquely identifying a providing authority of the enabling data set, and/or a timestamp. The security of the production monitoring is further increased in this manner.

It can occur in practice that an enabling data set is indeed provided correctly according to an order data set, but it is later determined that individual data is no longer relevant or that the production cannot be performed as planned. For example, the production device can be defective, so that a different production device must be used instead. This is not possible, however, if the enabling data set has already been issued for the defective production device, and thus cannot be used with a different production device. In order to avoid the necessity of generating the enabling data sets again in such cases, it is provided according to a an optional feature that the enabling data set can be modified depending on modification data. The enabling data set can thus be flexibly adapted. A separate authorization is preferably necessary for a modification, and can be issued by the providing authority, for example. One example of such a modification is that an identifier for uniquely identifying the production device and/or the production data set is changed. It is, however, preferred that enabling data sets can generally not be modified at all in order to enhance the security provided by the system. In this respect, enabling data sets are preferably stored in non-fungible tokens or are part of non-fungible tokens, respectively. These non-fungible tokens preferably cannot be modified after their generation. Therefore, a new enabling data set can be generated and provided in case the original enabling data set cannot be used or has been invalidated without a successful production.

According to a further consideration, a method for providing production data sets for electronically monitoring production is disclosed. The method is preferably performed by a providing authority and comprises providing at least one production data set depending on an identifier for identifying the production data set. In other words, a production data set is not provided to a requesting authority until the requesting authority can identify the relevant data set by means of a previously defined identifier.

The production data set can be provided particularly for a production device and/or an associated operating authority, wherein the production device is operated depending on an enabling data set in order to manufacture a product on the basis of the production data set.

One such production data set comprises general information making it possible to manufacture a predetermined product. The information is preferably present in the form of machine instructions or in machine language able to be read by the production device and directly applied for actuating the production device. The machine instructions are ideally prepared for this purpose in a standardized data format, such as in an NC file. In this manner, the production data set is compatible with a plurality of different production devices supporting the data format. In addition, the scope of data of the production data set remains compact, so that advantageous use in networked production architectures is possible. It is also conceivable, however, that the production device comprises more abstract information about the product to be produced, such as geometric dimensions, from the point of view of a production device. This information can, however, be interpreted by the production device, for example, and converted into machine language, if supported by the production device.

The method for providing production data sets can also be part of the method described above, wherein at least one enabling data set is provided. It is particularly thereby also possible that enabling data sets and production data sets are provided by a single providing authority, that is, by a “single source”.

Features of the method for providing enabling data sets can be at least partially implemented in the method for providing production data sets. For example, the method can comprise providing the production data set in an encrypted form.

According to a further consideration of the invention, a providing device is disclosed, said device being designed for implementing the electronic production monitoring according to the method described above. The providing device preferably comprises a memory and a processor, wherein a computer program is saved in the memory and has commands causing a method according to any one or more of the embodiments described above to be performed by the processor when executed by the same. The providing device can be implemented particularly by a computer, preferably by a server.

According to a further consideration, a production device having a communications interface for receiving at least one enabling data set and/or at least one production data set for the production device is disclosed. The production device further comprises at least one controller adapted for processing, particularly for authenticating, the enabling data set and/or the production data set. The control device is further adapted for operating the production device depending on the enabling data set in order to manufacture a product on the basis of the production data set. The production device can generally be a device for manufacturing three-dimensional components, for example, an additive production device (e.g., 3D printer).

The production device is adapted for processing the enabling data sets and production data sets and thus has the required data processing means. In order to ensure security of the production monitoring with respect to the production device as well, the production device is preferably set up so that the data sets cannot be read at the production device by unauthorized third parties.

In order to protect the data sets at the production device, it is provided according to a further embodiment that the production data set comprises a secured data processing area for processing the enabling data set and/or the production data set. The secured data processing area is protected against access by unauthorized authorities, in that the data processing area is separated from a main data processing area of the production device. Communication with the secured data processing area is thus possible only by means of secured interfaces.

The secured data processing area can be implemented at least partially in the form of an encapsulated software library implemented at the factory or subsequently in the production device.

The secured data processing area preferably comprises a secured memory wherein the production data set and/or access data for reading the production data set can be saved. The memory can be secured, for example, in that access to the memory is possible only by means of a secure interface of the secured data processing area.

It is understood that the production device, together with one or more of the described authorities, forms a system for electronically monitoring production.

A further consideration of electronically monitoring production relates to a data structure comprising a plurality of enabling data sets saved in decentralized manner and a plurality of production data sets saved on a centralized server. Each of the enabling data sets is associated with one of the production data sets, so that an arbitrary or predetermined production device can be operated depending on one of the enabling data sets in order to manufacture a product on the basis of the associated production data set. The data structure can be at least partially implemented by means of a blockchain. This enables a particularly high level of security while simultaneously efficiently using existing hardware resources.

### BRIEF DESCRIPTION OF THE DRAWINGS

The invention is explained below using the drawings solely as examples. The drawings show in detail:

FIG. 1 a schematic having elements for electronically monitoring production;

FIG. 2 a production device for implementing the electronic production monitoring according to FIG. 1;

FIG. 3 a method for implementing the electronic production monitoring according to FIG. 1 according to a first consideration; and

FIG. 4 a method for implementing the electronic production monitoring according to a second consideration.

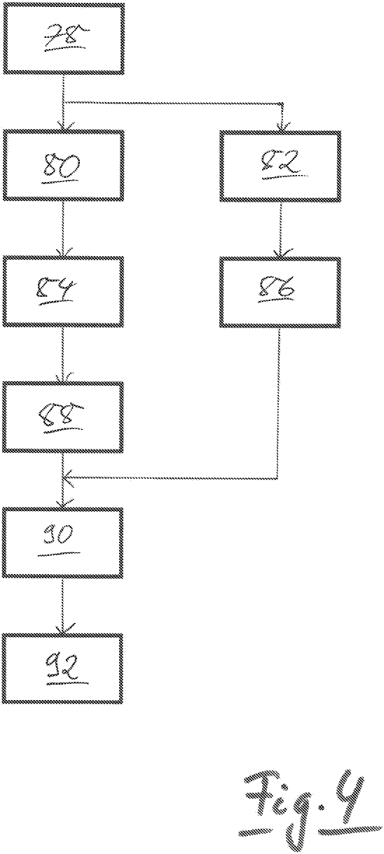

Functionally identical components are labeled with the same reference numeral.

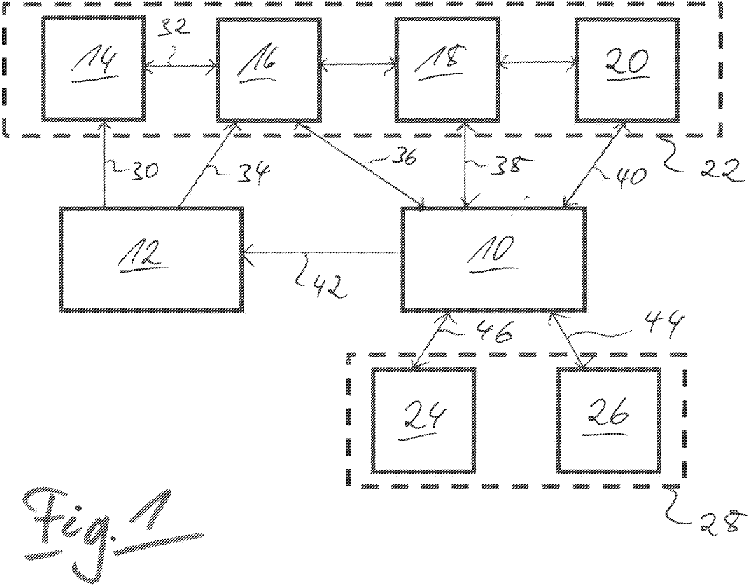

FIG. 1 shows a schematic having elements for electronically monitoring a production device 10. It is assumed that an ordering authority 12, such as a repair shop, would like to operate the production device 10 in order to obtain a product 42, such as a particular component. To this end, the ordering authority 12 can initially generate a first order data set 30 having identification data of the ordering authority 12 by means of a terminal device, not shown, (such as a smartphone or the like) and transmit the same to an authorizing authority 14. The authorizing authority 14 determines by means of the order data set 30 whether the ordering authority 12 can receive authorization for using the production device 10. If so, the authorizing authority 16 generates an authorizing data set 32 on the basis of the first order data set 30.

The authorizing data set 32 represents authorization for the ordering authority 12 to use the production device 10, particularly by providing one or more enabling data sets 36 as described in more detail below.

The ordering authority 12 further generates a second order data set 34 transmitted to a first providing authority 16. Said step can in turn be performed by means of a terminal device, such as a smartphone or tablet. The first providing authority 16 then checks whether the ordering authority 12 has sufficient authorization that one or more enabling data sets 36 according to the second order data set 34 may be provided. For determining the authorization, the first providing authority 16 receives the authorizing data set 32 from the authorizing authority 14 or requests said data set from the authorizing authority 14. When the authorization of the ordering authority 12 has been successfully determined, the enabling data set 36 is generated on the basis of the second order data set 34.

The second order data set 34 comprises information about the product 42 to be manufactured. Said information is processed by the providing authority 16 in that the enabling data set 36 comprises an identifier for uniquely identifying a production data set 38 for producing the product 42. The production data set 38 is saved in encrypted form in a second providing authority 18.

In addition to the identifier for identifying the production data set 38, the enabling data set 36 further comprises an identifier for identifying the production device 10 and access data for decrypting the production data set 38. The enabling data set 36 is transmitted to the production device 100 and provided to the production device 10 in this manner.

In response to receiving the enabling data set 36, said data set is processed by the production device 10 and evaluated, particularly with respect to the various data present in the enabling data set 36. The enabling data set 36 is first authenticated in that authentication data of the enabling data set 36 is transmitted to an authenticating authority 20. Once the authenticating authority 20 has confirmed the authenticity of the enabling data set 36, said confirmation is made known to the production device 10. The production device 10 then proceeds with further processing of the enabling data set 36.

The production data set 38 is invoked by means of the identifier present in the enabling data set 36 for identifying the production device 38 to the second providing authority 18 and transmitted to the production device 10. After the production data set 38 has been received, said data set is decrypted using the access data of the enabling data set 36 and further access data saved in the production device 10 and is made usable in this manner.

The production device 10 also determines whether the identifier for identifying the production device 10 matches a reference indicator saved at the production device 10. If so, the production device 10 is enabled for operating for manufacturing the product 42.

An operating authority 26 of the production device 10 is informed of the enabling of the production device 10. The operating authority 26 then starts operating the production device 10 in order to manufacture the product 42 according to the production data set 38. To this end, the operating authority 26 transmits control data 44 to the production device 10, for example, in the form of input data for initiating the desired operation of the production device 10 and setting configuration parameters as needed.

The product 42 produced is inspected by an inspecting authority 24, that is, is checked with respect to the desired quality of the product 42. For example, a check is made as to whether the product 42 has a desired surface finish and shape. The inspecting authority 24 transmits the result of said inspection in the form of inspecting data 46 to the production device 10. For example, an assessor enters the inspecting data 24 at an operator interface of the production device 10. The inspecting authority 24 can also monitor quality during manufacturing and can interrupt the operation of the production device 10 as needed in order to avoid unnecessary manufacturing errors.

The authorities 14, 16, 18, and 20 implement first monitoring authorities 22 of the electronic production monitoring and serve for executing communications between the ordering authority 12 and the production device 10. Communications are implemented in the sense of production monitoring such that the production device 10 can be actuated reliably and correctly in order to manufacture the desired product 42 at the intended level of quality.

The authorities 14, 16, 18, and 20 are shown separately in the schematic of FIG. 1. Said authorities can, however, be consolidated partially or completely in one or more authorities, deviating from the depiction. For example, the first providing authority 16 and the authenticating authority 20 can be consolidated in one authority. It is further possible to implement the first providing authority 16 and the second providing authority 18 as a common providing authority.

The authorities 14, 16, 18, and 20 can each be implemented by servers, preferably electronically networked to one another, and can be connected to the production device 10 by means of the Internet. The ordering authority 12 can be further electronically connected to the authorizing authority 14 and the first providing authority 16, particularly by means of a public communications network such as the Internet. The authorities 14, 16, 18, and 20, together with the production device 10, represent a networked, decentralized production architecture having electronic production monitoring.

Each of the authorities 14, 16, 18, and 20 can be associated with various persons, said persons monitoring or influencing the operating of the authorities.

The inspecting authority 24 and the operating authority 26 implemented two monitoring authorities 28 of the production monitoring, wherein the authorities 24 and 26 can be consolidated in one, common authority. For example, the functions of the inspecting authority 24 can be performed by the operating authority 26.

The authorities 24 and/or 26 are preferably associated with respective persons, for example, an assessor in the case of the inspecting authority 24, and an operator of the production device 10 in the case of the operating authority 26. The inspecting authority 24 and the operating authority 26 can, however, be supplemented with electronic accessories or implemented by means of electronic devices (not shown).

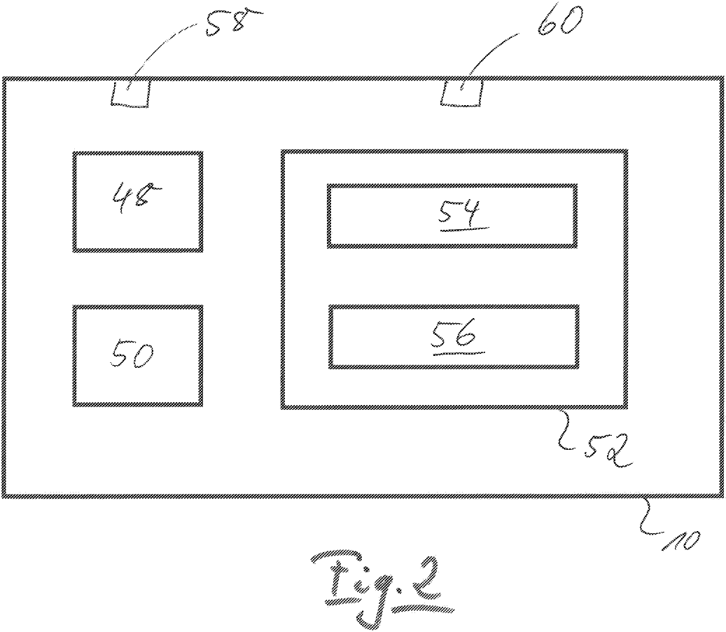

Further considerations of the production device 10 are described below with reference to FIG. 2. The production device 10 is shown purely schematically in FIG. 2 and comprises a first controller 48 and a production module 50. The controller 48 is connected to the production module 50 in order to control the production module 50 depending on control data of the controller 48. The production module 50 can be a printing unit of a 3D printer, for example.

The production device 10 also comprises a secured data processing area 52 separate from the remainder of the data processing area of the production device 10, particularly from the first controller 48. Access to the controller 48 thus does not simultaneously enable access to the data processing area 52. In this manner, the data processing area 52 is protected against unauthorized, external access.

The production device 10 comprises an operator interface 58 provided for entering control data, for example, by the operating authority 26 and/or the inspecting authority 24 (FIG. 1). The production device 10 further comprises a communications interface 60 connected to the secured data processing area 52 and particularly serving for receiving enabling data sets 36 and production data sets 38 and for transmitting authentication data 40. In addition, further communications interfaces can be provided, but are separate from the communications interface 60 and do not compromise the security requirements for the data processing area 52 in this respect (not shown).

The data processing area 52 comprises a second controller 54 and a memory 56 wherein access data for reading production data sets 38 are saved. The second controller 54 is particularly adapted for receiving and processing an enabling data set 36 and a production data set 38 by means of the communications interface 60. To this end, the production data set 38 can be decrypted on the basis of the access data saved in the memory 56.

The controller 54 is further adapted for authenticating the enabling data set 36 and for generating control data on the basis of the decrypted production data set 38 for transmitting to the first controller 48. The controller 48 controls the production module 50 for manufacturing the product 42 using the control data.

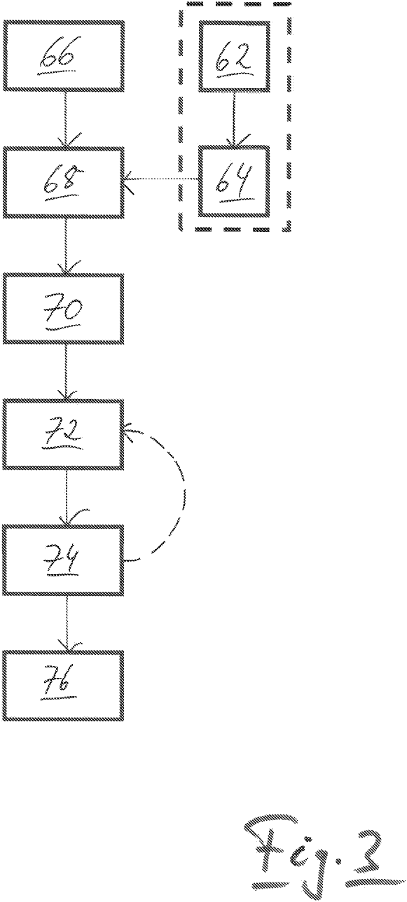

A method according to a further consideration of the electronic production monitoring of FIG. 1 is described below with reference to FIG. 3. The first order data set 30 is first generated (step 62) in order to provide an authorizing data set 32 on the basis thereof (step 64). Steps 62 and 64 are optional. The second order data set 34 is generated in step 66. The enabling data set 36 is provided (step 68) on the basis of the second order data set 34, wherein said providing can optionally be done depending on the authorizing data set.

The production data set 38 is provided on the basis of the enabling data set 36 and represents an electronic production specification of the product 42 to be manufactured, for example, in the form of an NC file or build job (step 70). The production device 10 is then operated depending on the provided enabling data set 36 and on the basis of the production data set 38 in order to manufacture the product 42 (step 72).

The manufacturing process is monitored in step 74. If the manufacturing of the product 42 is not successful, for example, due to a defect of the production device 10, then a new enabling data set 36 is provided for another manufacturing attempt. The step 72 can then be performed again. The successful manufacturing of the product 42 is confirmed by inspecting data 46. The product 42 is then provided for the ordering authority 12 or for a predetermined third party (step 76).

A method according to a further consideration of the electronic production monitoring of FIG. 1 is described below. The method begins in step 78 by generating a symmetric key used for encrypting and decrypting the production data set 38. The providing authority 16 generates the key preferably by means of a private key.

The symmetric key is encrypted in step 80 by means of a public key of the production device 10 and is added to the production device 36 along with further information. The symmetric key is also used for encrypting the production data set 38 (step 82).

In step 84, the enabling data set 36 is provided to the production device 10. In addition, the encrypted production data set 38 is provided to the production device 10 (step 86). The enabling data set 36 and the production data set 38 are now available to the production device 10 for further processing.

In step 88, the symmetric key present in the enabling data set 36 in encrypted form is decrypted. The symmetric key is then used for decrypting the production data set 38 (step 90). The production device 10 is then operated depending on the enabling data set 36 in order to manufacture the product 42 on the basis of the production data set 38 (step 92).

LIST OF REFERENCE NUMERALS

| | |
|---|---|
| 10 | Production device |
| 12 | Ordering authority |
| 14 | Authorizing authority |
| 16 | First providing authority |
| 18 | Second providing authority |
| 20 | Authenticating authority |
| 22 | First monitoring authorities |
| 24 | Inspecting authority |
| 26 | Operating authority |
| 28 | Second monitoring authorities |
| 30 | First order data set |
| 32 | Authorizing data set |
| 34 | Second order data set |
| 36 | Enabling data set |
| 38 | Production data set |
| 40 | Authentication data |
| 42 | Product |
| 44 | Control data |
| 46 | Inspection data |
| 48 | First controller |
| 50 | Production module |
| 52 | Data processing area |
| 54 | Second controller |
| 56 | Memory |
| 58 | Operator interface |
| 60 | Communications interface |
| 62 | Generating a first order data set |
| 64 | Providing an authorizing data set |
| 66 | Generating a second order data set |
| 68 | Providing an enabling data set |
| 70 | Providing a production data set |
| 72 | Operating the production device |
| 74 | Monitoring the manufacturing |
| 76 | Providing the product |
| 78 | Generating a key |
| 80 | Encrypting the key |
| 82 | Encrypting the production data set |
| 84 | Providing the enabling data set |
| 86 | Providing the production data set |
| 88 | Decrypting the key |
| 90 | Decrypting the production data set |
| 92 | Operating the production device |

1-20. (canceled)

21. A method for electronic production monitoring, the method comprising: providing one or more enabling data sets to one or more production devices, the one or more production devices using the one or more enabling data sets and a production data set to produce a product.

22. The method according to claim 21, wherein the enabling data set is at least one of transmitted to the one or more production devices or authenticated, using an authorizing data set, and transmitted to the one or more production devices to enable the one or more production devices to use the production data set to produce the product.

23. The method according to claim 21, wherein the enabling data set comprises a first identifier that is used to identify the production data set, the production data set, in response to being identified, is provided to the one or more production devices by at least one of a central server or a local memory of the one or more production devices.

24. The method according to claim 21, wherein the enabling data set is at least one of an element of a decentralized data structure or a block of a blockchain.

25. The method according to claim 21, wherein the one or more production devices comprise a predetermined production device that is enabled by the enabling data.

26. The method according to claim 21, wherein the enabling data set limits the use of the production data set to producing a single copy of the product.

27. The method according to claim 21, wherein the enabling data set is not modified, duplicated, or subject to generation of a further enabling data set.

28. The method according to claim 21, wherein only one enabling data set is required to operate the device to produce the product.

29. The method according to claim 21, wherein generation or use of the enabling data set does not depend on the content of another enabling data set.

30. The method according to claim 21, wherein the enabling data set is provided depending on an authorizing data set, the enabling dataset being associated with the one or more production devices and the production data set, and the authorizing data set being associated with the enabling data set.

31. The method according to claim 21, wherein the enabling data set is implemented as a non-fungible token.

32. The method according to claim 21, further comprising at least one of, depending on a first confirmation of successful production, invalidating the enabling data set or, depending on a second confirmation of unsuccessful production, generating a new enabling data set for another production attempt.

33. The method according to claim 32, wherein the first confirmation is generated by using at least one of first automatically generated operating data of the production device or first input data of an inspecting authority for inspecting the product, the second confirmation being generated by using at least one of second automatically generated operating data of the one or more production devices, second input data of the inspecting authority, or third input data of a monitoring authority.

34. The method according to claim 21, further comprising receiving from an ordering authority an order data set that comprises information about the product, the enabling data set being generated by a providing authority on the basis of the order data set and being provided for an operating authority of the one or more production devices to produce the product.

35. The method according to claim 21, wherein the production data set is at least one of encrypted, partially encrypted, or comprises access data for reading the production data set.

36. The method according to claim 35, wherein the access data comprises at least one of a first key for decrypting the production data set or a hash value for the production data set, the first key being at least one of generated by using a second key or encrypted using a third key.

37. The method according to claim 21, wherein the enabling data set comprises at least one of a second identifier for uniquely identifying the one or more production devices, a third identifier for uniquely identifying the enabling data set, a fourth identifier for uniquely identifying a providing authority associated with the enabling data set, or a timestamp.

38. The method according to claim 21, wherein the method is a computer-implemented method that is implemented on a system that comprises one or more processors and a non-transitory computer-readable medium or media, the non-transitory computer-readable medium or media comprising one or more sets of instructions which, when executed by at least one of the one or more processors, causes the method to be performed.

39. A production device comprising:
a communications interface that receives at least one of an enabling data set or a production data set;
a secured data processing area that processes at least one of the enabling data set or the production data set; and
one or more controllers that authenticate at least one of the enabling data set or the production data set, the one or more controllers using at least one of the enabling data set or the production data set to cause the production device to produce a product.

40. A data structure for electronic production monitoring using a production device, the data structure comprising a plurality of enabling data sets that are stored in decentralized locations and a plurality of production data sets that are stored on centralized server, each of the enabling data sets being associated with one of the plurality of production data sets, the production device using at least one of the enabling data set or the production data set to produce a product, the data structure being at least partially implemented by using a blockchain.
